(19) United States
(12) Patent Application Publication
(10) Pub. No.: US 2008/0011243 A1
(43) Pub. Date: Jan. 17, 2008

(54) Interactive laser pet toy with multiple images

(76) Inventor: Reynolds Ellsworth Moulton, Brooklyn, NY (US)

Correspondence Address: WILLIAM G. FELLOWS, 8610 SNOWDEN LOOP, LAUREL, MD, 20708, US

(21) Appl. No.: 11/488,804

(22) Filed: Jul. 17, 2006

(51) Int. Cl. A01K 29/00

(52) U.S. Cl. 119/707

(57) ABSTRACT

The present invention has a hand held laser projector. A laser source and several image templates provided integrally to project several images of animals or insects or attractive symbols or patterns, are housed inside a device case. A dial is provided at one side of case to select one image template to project a desired image or pattern. A button and a battery cover are provided at the top and bottom side of the case. A key chain is attached to one side edge of the case.

### FIELD OF THE INVENTION

The present invention relates to a recreational and amusement devices for domestic animals and more particularly to an exercising, entertaining and stimulating devices for pet animals like dogs, cats, etc.

### BACKGROUND OF THE INVENTION

The pet owners currently find difficulty in controlling the pet obesity, which is a growing epidemic. The American Veterinarian Association estimates that an average 44% of pet animals are overweight. Hence there is a need to motivate the pet to do exercise to reduce obesity. Moreover the domesticated (pet) animals like cats are not characteristically inclined towards voluntary aerobic exercises. Hence it becomes the major task of the pet owners to find ways and means to create situations of sufficient interest to the pet animals to induce even short lived and modest exercises to maintain the health and the well-being of the pet animals. The quick, spontaneous and dynamic movements are needed to tone the muscle and fine tune the intrinsic play skills of the pets. Also the pets feel boredom without any exercise or playful activity. So, there is a need to exercise and entertain the pet animals by using their characteristic behavior towards hunting and chasing of moving objects by providing images of moving objects as preys. The images of the moving objects may be similar to that of animals, insects etc.

The following prior arts mention about the efforts taken to project images, sounds and lights to entertain the pet animals and to stimulate the exercise in the pet animals.

The U.S. Pat. No. 6,651,591 indicates an automatic laser pet toy and exerciser which projects a laser beam to provide a virtual prey for animals to provide stimulation and exercise for pet animals projects only a laser beam spot. The U.S. Pat. No. 5,443,036 provides a method for exercising cat in which a single light pattern image is used as a target object. The U.S. Pat. No. 5,844,377 explains about a kinetically multicolored light source device in which the light source produces several primary colors to generate a multicolored illuminated display. In the U.S. Pat. No. 6,557,495, a laser pet toy for cats projects only a laser beam spot and not a laser image of animals and insects. The U.S. Pat. No. 5,934,223 describes a pet toy for entertaining pet animals, in which only an ordinary light source and not a laser source is used to project the image. The U.S. Pat. No. 6,505,576 indicates a pet toy using a light source and not a laser beam to project the images to entice the pets. The U.S. Pat. No. 5,651,332 explains about an interactive pet device provided with an electrically animated mouse suspended inside a simulated mouse hole and animated to move randomly for preset time. A cat toy for triggering the play attack behavior, mentioned in the U.S. Pat. No. 5,743,215 has a flexible and durable target attached to one end of a pole and reel assembly so that the target is moved away to evoke playful behavior and attack behavior of pet animals. The pet exerciser and toy device for cats indicated in the U.S. Pat. No. 5,755,184 uses only the bright colored silicon rubber strips to entice the pets and not the laser generated image. In the US patent 20010037773 a pet toy is provided with a drive motor to rotate a laser projecting beam to project a laser beam out side the device housing. The US patent 20020002955 describes about a laser pet toy provided with motors to effectively move a laser beam to project a moving laser beam spot outside the enclosure of the device.

Thus the currently available laser pet toy and exerciser devices project only a single image and do not generate multiple fanciful images. Moreover several attachments have to be attached to the currently available laser toy device to project several images so that only one attachment can be attached to the device at one time and the attachment has to be changed every time to project a different image.

Hence there is a need to provide multiple fanciful images to the pet animals using a single device to attract the pets and to provide an interactive play between the owner and the pet animal, thereby enhancing the stimulation of the pet animals and stimulating the exercise in the pet animals to improve the health and the well-being of the pet animals.

### OBJECTS OF THE INVENTION

The primary object of the invention is to provide multiple images to attract the pets using a single laser pet toy.

Another object of the invention is to provide an interactive play between the pet owner and the pet.

Another object of the invention is to provide a multiple images of attractive symbols to stimulate the exercise in the pet.

Another object of the invention is to enable the pet to access the projected several images to increase the level of excitement in the pet.

Another object of the invention is to provide the multiple images to enhance the playing experience and to maintain natural skills such as reflex and reaction times of the pet.

Another object of the invention is to provide a variety of play and to increase the interaction between the pet and the pet owner to prevent the boredom of the pet and to enhance the human animal bond.

Another object of the invention is to provide a desired and selective image to the pet to improve the attractiveness of the pet and to entice the pet to play and exercise.

Another object of the invention is to provide a selective image pattern to the pet to indicate the emotion of the pet owner.

These and other objects, features and advantages of the present invention will become apparent from the following description and accompanying drawings of one embodiment.

### SUMMARY OF THE INVENTION

The present invention has a hand held laser beam projector. A laser source and several image templates that are used to provide several desired and selective images of the insects or animals or patterns, are provided in a device housing installed with a button at the topside of the housing to activate the laser projector. The laser projector is powered with the electric power from the battery power supply unit. A battery cover is attached detachably to the device housing by using several screws. The laser source emits a laser beam with a wavelength of 630-680 nm and with a maximum laser output of less than 5 mW. A dial is provided at another side of the housing to select one image template from the several image templates to project a desired image and to change the shape of the projected image. A key chain is detachably attached to the laser projector device through a hole provided at one side edge of the device housing. The button at the upper side of the housing is printed with a color or pattern that is different from that provided at the remaining portions of the device housing

### BRIEF DESCRIPTION OF THE DRAWINGS

FIG. 1 shows the topside view, indicating the laser and the button, of the interactive laser pet toy of this invention

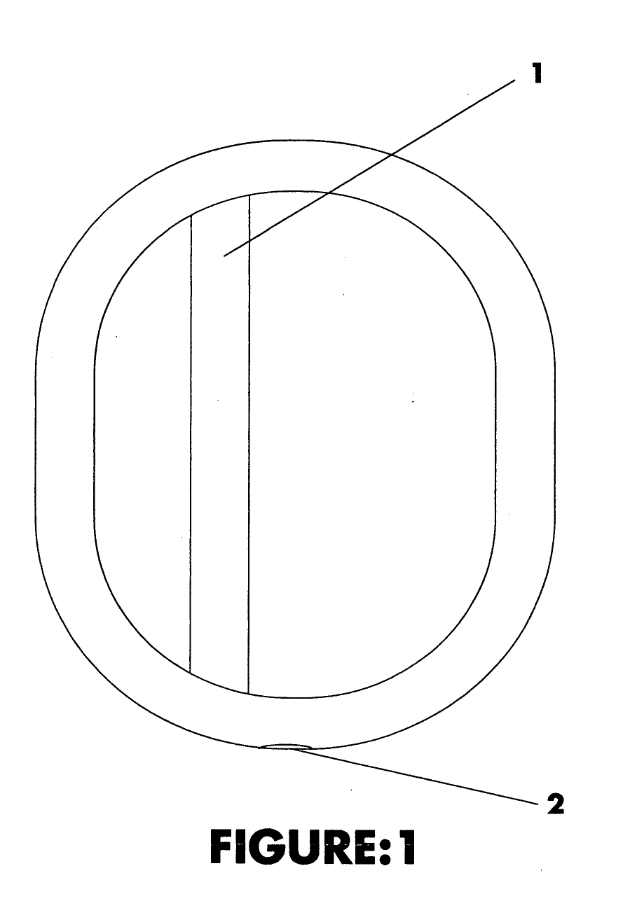

FIG. 2 shows the perspective view, indicating the button, the laser and the dial of the interactive laser pet toy of this invention from one side.

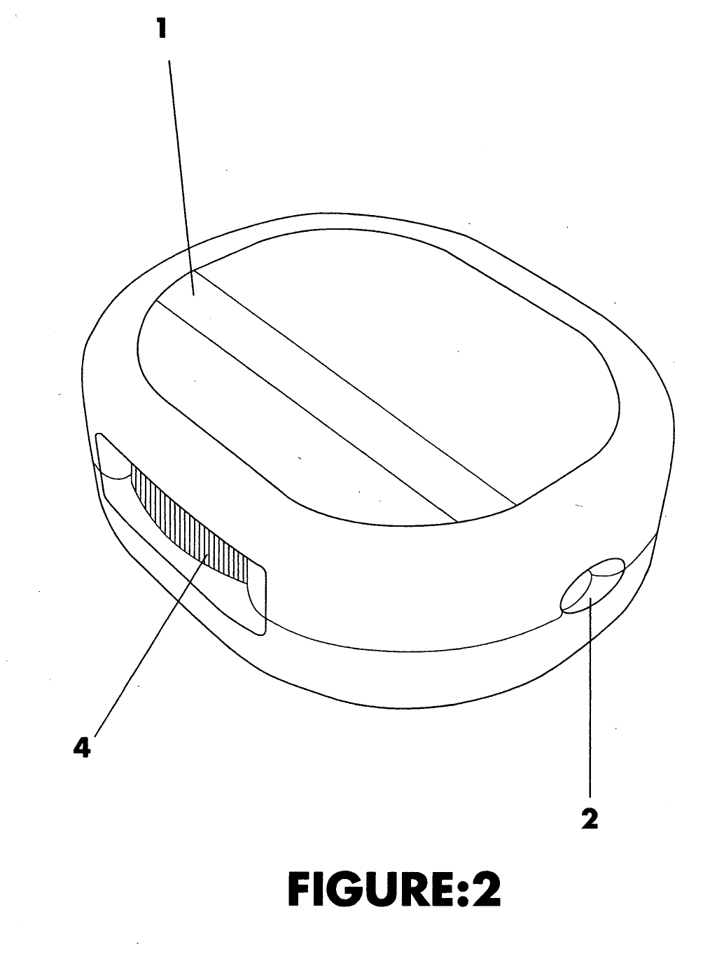

FIG. 3 shows the perspective view, indicating the hole for key chain, the dial and the battery cover of the interactive laser pet toy of this invention from the bottom side.

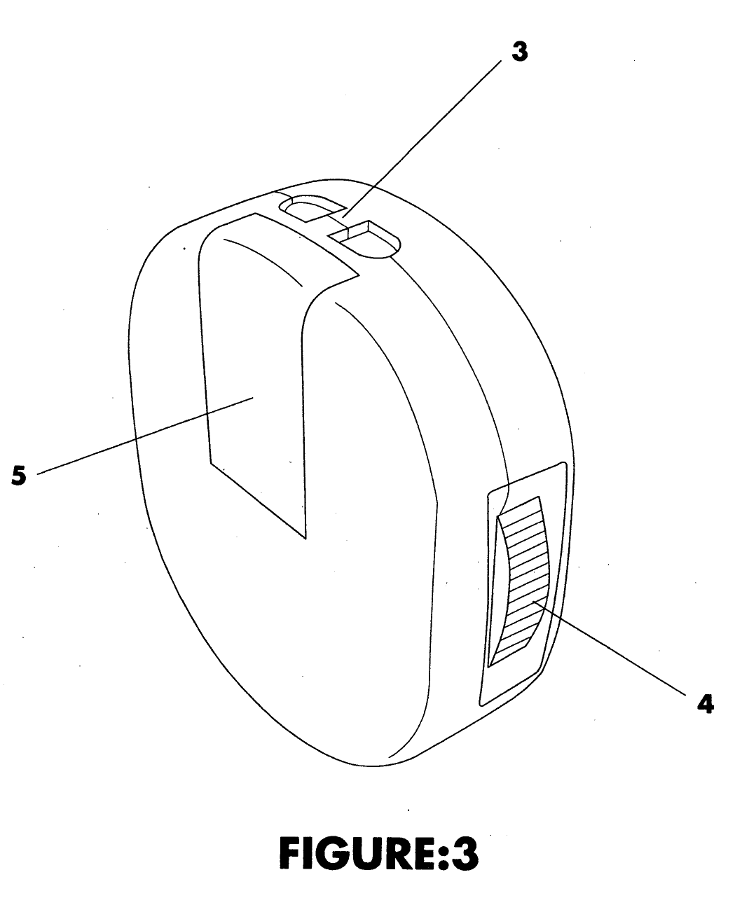

### DETAILED DESCRIPTION OF THE PREFERRED EMBODIMENTS

The laser pet toy of the present invention has a hand held laser projector provided with a laser source 2 and several image templates that are integrally arranged inside the main body of the device. The integrated image templates are used to project several different images of attractive symbols so that one image is selected by a means for selecting and the selected image is projected using the laser beam emitted by the laser source 2. The laser source 2 emits a laser beam with a wavelength of 630-680 nm and with a maximum laser output intensity of less than 5 mW. The laser source 2 is a class III laser, which satisfies the specifications and the standards, stipulated for a consumer use. A button 1 provided at the topside of the main body activates the laser source 2. The button 1 is printed with a color or pattern that is different from that of the rest of the main body.

The selector unit used in one embodiment of the invention is a dial 4 that is provided at one side of the main body. The dial 4 is used to select one image template from several image templates and to change the shape of the projected image pattern to entice the pet or to indicate the emotion of the pet owner so that only one desired image or pattern is projected at one time.

The projected image may be the image of an insect like dragonfly or an animal to attract the pet. Sometimes an image pattern like the image of a heart pattern is projected to indicate the emotion of the pet owner. Thus the laser pet toy of this invention projects several images or attractive symbols one by one based on the selection of the pet owner or user of the device to attract the pets, to provide stimulation to the pet, to stimulate the pet to do exercise to maintain the natural skills such as reflex and reaction time of the pet and to provide an interactive play between the pet owner and the pet thereby avoiding the boredom of the pet and enhancing the human animal bond. In one embodiment of this invention, the device is used to project at least twelve images. The laser pet toy of this invention is operated with the power supplied from a battery means. A battery cover 5 is attached to the bottom side of the main body by using a means for fastening or securing such as screws. A means for holding the device, preferably a key chain, is attached to the device through the holes, 3 provided in one side of the main body.

Thus the laser pet toy of this invention projects a desired and selective fanciful image, or attractive symbol or pattern to attract the pets and to stimulate the exercise in the pets thereby improving the health and the well being of the pet. This invention projects the specific images of preys to pets by changing the projected images of attractive symbols and patterns to increase the level of the excitement for the pet and to enhance the playing experience and to maintain the natural skills such as reflex and reaction times of the pet thereby providing a variety of play and interaction between the owner and the pet and improving the human animal bond. Several images of attractive symbols are projected using a single device to prevent the boredom of the pet and to enhance the stimulation of the pet. Sometimes a desired pattern is projected to indicate the emotion of the pet owner.

Whilst the present invention has been described in accordance with a preferred embodiment, it is believed that those familiar with the art will recognize the advancement of the present invention over the prior art and will understand that numerous modifications can be made without deviating from the spirit and scope of the present invention.

What is claimed is:

1. Interactive laser pet toy with multiple images comprising
a) A hand held laser projector,
b) Several image templates provided integrally inside the main body containing the laser projector to project several mutually different images and patterns
c) A means for selecting one image template from several templates to project one desired or specific image or pattern to entice pet and to stimulate exercise in pet

2. The interactive laser pet toy with multiple images as set forth in claim. 1, wherein the means for selecting one image template from several image templates, is a dial.

3. The interactive laser pet toy with multiple images as set forth in claim. 2, wherein the dial is arranged at one side of the device main body, housing the hand held laser projector.

4. The interactive laser pet toy with multiple images as set forth in claim. 1, wherein several image templates project the images of attractive symbols or insects or animals or patterns.

5. The interactive laser pet toy with multiple images as set forth in claim. 1, wherein the hand held laser projector has a laser source to emit a laser beam with a wavelength of 630-680 nm and with a maximum laser output of not less than 5 mW.

6. The interactive laser pet toy with multiple images as set forth in claim. 1, wherein a detachable battery cover is attached to the device main body through several means of fastening or securing.

7. The interactive laser pet toy with multiple images as set forth in claim. 6, wherein the means of securing or fastening used to attach the battery cover detachably to the device main body, consists of screws.

8. The interactive laser pet toy with multiple images as set forth in claim. 1, wherein a button is provided at the topside of the device main body.

9. The interactive laser pet toy with multiple images as set forth in claim. 8, wherein the button is printed with different color or pattern that is different from that of the color or pattern of the rest of the housing.

10. The interactive laser pet toy with multiple images, as set forth in claim. 1, wherein a means for holding the device main body is detachably attached to the device main body through a hole provided at one side of the main body.

11. The interactive laser pet toy with multiple images as set forth in claim. 10, wherein the means for holding the device main body is a key chain.
